(19) United States
(12) Patent Application Publication
(10) Pub. No.: US 2024/0002006 A1
(43) Pub. Date: Jan. 4, 2024

(54) CONTROL DEVICE FOR HUMAN-POWERED VEHICLE

(71) Applicant: Shimano Inc., Osaka (JP)

(72) Inventor: Satoshi SHAHANA, Osaka (JP)

(21) Appl. No.: 18/206,875

(22) Filed: Jun. 7, 2023

(30) Foreign Application Priority Data
Jun. 29, 2022 (JP) 2022-104539

(51) Int. Cl. B62J 45/00

(52) U.S. Cl. CPC B62J 45/00

(57) ABSTRACT

A control device is provided for a human-powered vehicle that includes a crank axle configured to receive a human driving force, a first rotational body connected to the crank axle, a second rotational body connected to a wheel, a transmission body engaged with the first and second rotational bodies to transmit a driving force between the first and second rotational bodies, and a motor configured to drive the transmission body. The control device includes an electronic controller configured to control the motor. Upon a predetermined condition being satisfied, the electronic controller drives the motor so that a rotational torque of the first rotational body produced by the motor is kept less than or equal to a predetermined torque which is 1 Nm or greater and 10 Nm or less. The predetermined condition includes a first condition in which rotation of the crank axle is stopped.

### CROSS-REFERENCE TO RELATED APPLICATIONS

This application claims priority to Japanese Patent Application No. 2022-104539, filed on Jun. 29, 2022. The entire disclosure of Japanese Patent Application No. 2022-104539 is hereby incorporated herein by reference.

### BACKGROUND

### Technical Field

The present disclosure generally relates to a control device for a human-powered vehicle.

### Background Information

Some human-powered vehicles include a motor to assist in propulsion of the human-powered vehicle. One example of such a human-powered vehicle is disclosed in U.S. Patent Application Publication No. 2016/0052594, which discloses a motor that transmits drive force to the vehicle.

### SUMMARY

An objective of the present disclosure is to provide a control device for a human-powered vehicle that controls a motor in a preferred manner.

A control device in accordance with a first aspect of the present disclosure is for a human-powered vehicle. The human-powered vehicle includes a crank axle, a first rotational body, a wheel, a second rotational body, a transmission body, and a motor. The crank axle is configured to receive a human driving force. The first rotational body is connected to the crank axle. The second rotational body is connected to the wheel. The transmission body is engaged with the first rotational body and the second rotational body to transmit a driving force between the first rotational body and the second rotational body. The motor is configured to drive the transmission body. The control device comprises an electronic controller configured to control the motor. In a case where a predetermined condition is satisfied, the electronic controller is configured to drive the motor so that a rotational torque of the first rotational body produced by the motor is kept less than or equal to a predetermined torque. The predetermined condition includes a first condition in which rotation of the crank axle is stopped. The predetermined torque is 1 Nm or greater and 10 Nm or less.

With the control device according to the first aspect, in a case where rotation of the crank axle is stopped, the control device drives the motor so that the rotational torque of the first rotational body produced by the motor is kept less than or equal to the predetermined torque. This controls the motor such that the motor limits the propulsion force applied to the human-powered vehicle while transmitting driving force to the transmission body.

In accordance with a second aspect of the present disclosure, the control device according to the first aspect is configured so that the predetermined torque is 2 Nm or greater and 10 Nm or less.

With the control device according to the second aspect, in a case where rotation of the crank axle is stopped, the motor further limits the propulsion force applied to the human-powered vehicle while transmitting driving force to the transmission body.

In accordance with a third aspect of the present disclosure, the control device according to the first or second aspect is configured so that the predetermined torque is set in accordance with a transmission ratio of the human-powered vehicle.

With the control device according to the third aspect, in a case where the predetermined condition is satisfied, the motor is controlled in accordance with the transmission ratio.

A control device in accordance with a fourth aspect of the present disclosure is for a human-powered vehicle. The human-powered vehicle includes a crank axle, a first rotational body, a wheel, a second rotational body, a transmission body, and a motor. The crank axle is configured to receive a human driving force. The first rotational body is connected to the crank axle. The second rotational body is connected to the wheel. The transmission body is engaged with the first rotational body and the second rotational body to transmit a driving force between the first rotational body and the second rotational body. The motor is configured to drive the transmission body. The control device comprises an electronic controller is configured to control the motor. In a case where a predetermined condition is satisfied, the electronic controller is configured to drive the transmission body by driving the motor at a predetermined current value or less. The predetermined condition includes a first condition in which rotation of the crank axle is stopped. The predetermined current value is greater than a standby current value of the motor and less than or equal to 5 amperes.

With the control device according to the fourth aspect, in a case where rotation of the crank axle is stopped, the control device drives the motor at the predetermined current value or less. This controls the motor such that the motor limits the propulsion force applied to the human-powered vehicle while transmitting driving force to the transmission body.

In accordance with a fifth aspect of the present disclosure, the control device according to the fourth aspect is configured so that the predetermined current value is less than or equal to 2 amperes.

With the control device according to the fifth aspect, in a case where rotation of the crank axle is stopped, the motor further limits the propulsion force applied to the human-powered vehicle while transmitting driving force to the transmission body.

In accordance with a sixth aspect of the present disclosure, the control device according to any one of the first to fifth aspects is configured so that the human-powered vehicle further includes a derailleur configured to operate the transmission body and shift a transmission ratio of a rotational speed of the wheel to a rotational speed of the crank axle. The predetermined condition further includes a second condition in which the derailleur operates the transmission body to shift the transmission ratio.

With the control device according to the sixth aspect, in a case where rotation of the crank axle is stopped and the transmission ratio is shifted, the control device controls the motor such that the motor limits the propulsion force applied to the human-powered vehicle. With the control device according to the sixth aspect, in a case where the transmission ratio is not shifted, the electronic controller does not drive the motor. This reduces electric power consumption.

In accordance with a seventh aspect of the present disclosure, the control device according to the sixth aspect is configured so that in a case where a speed of the human-powered vehicle is less than or equal to a predetermined first speed, the electronic controller is configured to drive the motor so as to apply a propulsion force to the human-powered vehicle in accordance with at least one of the human driving force and the rotational speed of the crank axle. The electronic controller is configured to control the derailleur. The electronic controller is configured so as not to actuate the derailleur upon determining the speed of the human-powered vehicle is in a predetermined speed range including the predetermined first speed in a case where the predetermined condition is satisfied.

The control device according to the seventh aspect does not actuate the derailleur if the speed of the human-powered vehicle is in the predetermined speed range including the predetermined first speed in a case where the predetermined condition is satisfied. This actuates the derailleur less frequently. Thus, the electronic controller reduces electric power consumption.

In accordance with an eighth aspect of the present disclosure, the control device according to any one of the first to seventh aspects is configured so that the predetermined condition further includes a third condition in which the wheel is rotating.

With the control device according to the eighth aspect, in a case where rotation of the crank axle is stopped and the wheel is rotating, the control device controls the motor such that the motor limits the propulsion force applied to the human-powered vehicle. With the control device according to the eighth aspect, in a case where the wheel is not rotating, the electronic controller does not drive the motor and thereby reduces electric power consumption.

In accordance with a ninth aspect of the present disclosure, the control device according to any one of the first to eighth aspects is configured so that the electronic controller is configured to determine that rotation of the crank axle is stopped in a case where a rotational speed of the crank axle is less than or equal to a predetermined rotational speed.

With the control device according to the ninth aspect, even if the crank axle has not completely stopped, the control device controls the motor such that the motor limits the propulsion force applied to the human-powered vehicle while transmitting driving force to the transmission body.

In accordance with a tenth aspect of the present disclosure, the control device according to any one of the first to ninth aspects is configured so that the electronic controller is configured to drive the motor so that a rotational speed of the first rotational body becomes less than or equal to an estimated rotational speed. The estimated rotational speed is calculated from a transmission ratio of the human-powered vehicle and a speed of the human-powered vehicle.

The control device according to the tenth aspect is configured to drive the motor so that the rotational speed of the first rotational body becomes less than or equal to the estimated rotational speed. This controls the motor such that the motor limits the propulsion force applied to the human-powered vehicle while transmitting driving force to the transmission body.

In accordance with an eleventh aspect of the present disclosure, the control device according to any one of the first to tenth aspects is configured so that in a case where the predetermined condition is satisfied, the electronic controller is configured to stop driving the motor in accordance with a load on the motor.

With the control device according to the eleventh aspect, in a case where the predetermined condition is satisfied, the control device restricts driving of the motor in a state in which the load on the motor is high.

In accordance with a twelfth aspect of the present disclosure, the control device according to the eleventh aspect is configured so that in a case where the electronic controller starts driving the motor as the predetermined condition is satisfied and the load on the motor then becomes greater than or equal to a predetermined load, the electronic controller is configured to stop driving the motor.

With the control device according to the twelfth aspect, in a case where the predetermined condition is satisfied, the control device restricts driving of the motor in a state in which the load on the motor is greater than or equal to the predetermined load.

In accordance with a thirteenth aspect of the present disclosure, the control device according to any one of the first to twelfth aspects is configured so that the predetermined condition includes a fourth condition in which the first condition is satisfied after a condition is satisfied in which the human driving force received by the crank axle is greater than or equal to a predetermined driving force.

With the control device according to the thirteenth aspect, in a case where rotation of the crank axle is stopped after the condition is satisfied in which the human driving force received by the crank axle is greater than or equal to the predetermined driving force, the control device controls the motor such that the motor limits the propulsion force applied to the human-powered vehicle.

The control device for the human-powered vehicle of the present disclosure controls the motor in a preferred manner.

### BRIEF DESCRIPTION OF THE DRAWINGS

Referring now to the attached drawings which form a part of this original disclosure.

FIG. 1 is a side elevational view of a human-powered vehicle including a human-powered vehicle control device in accordance with an embodiment.

FIG. 2 is a block diagram showing the electrical configuration of the human-powered vehicle shown in FIG. 1.

FIG. 3 is a cross-sectional view of a drive unit for the human-powered vehicle shown in FIG. 1.

FIG. 4 is a flowchart illustrating a control process executed by an electronic controller shown in FIG. 2 to control a motor and a derailleur.

FIG. 5 is a flowchart illustrating a control process executed by an electronic controller of a modified example to control a motor.

### DETAILED DESCRIPTION

Selected embodiments will now be explained with reference to the drawings. It will be apparent to those skilled in the human-powered field (e.g., the bicycle field) from this disclosure that the following descriptions of the embodiments are provided for illustration only and not for the purpose of limiting the invention as defined by the appended claims and their equivalents.

### First Embodiment

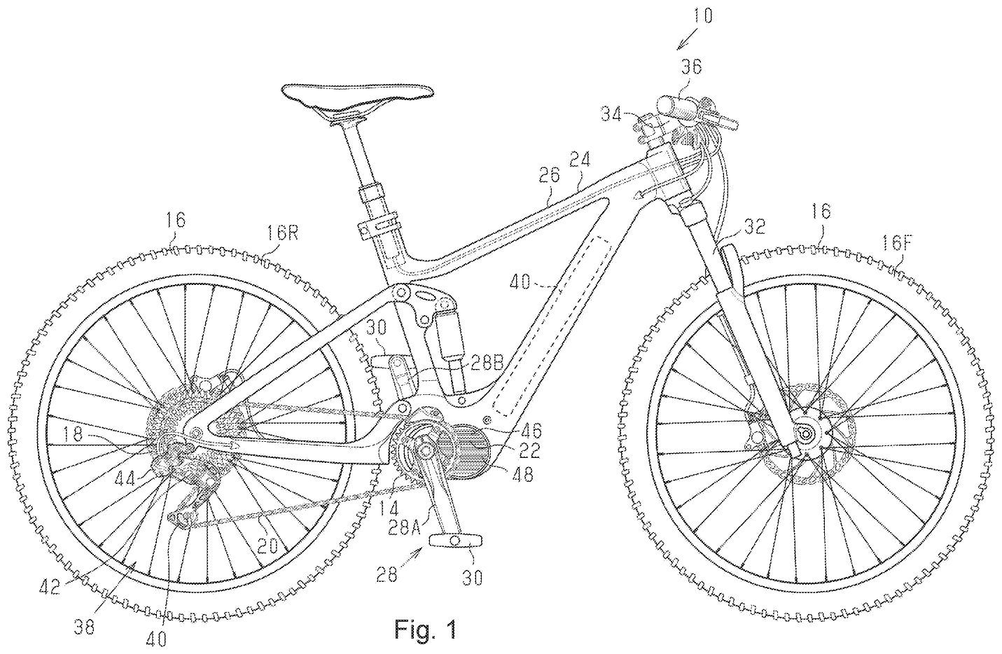

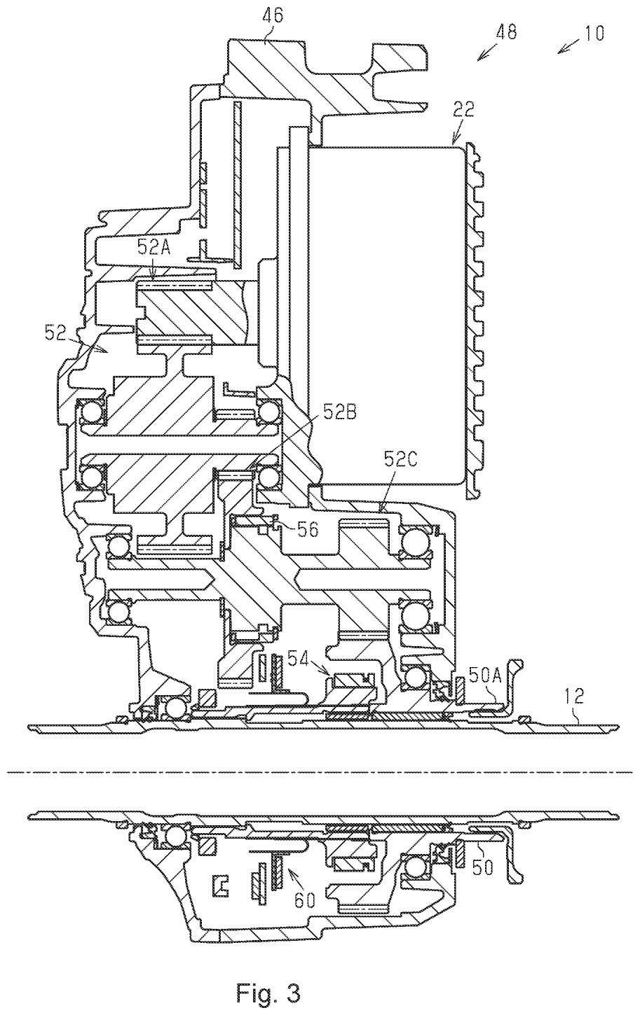

A control device 70 for a human-powered vehicle will now be described with reference to FIGS. 1 to 4. The human-powered vehicle is a vehicle that includes at least one wheel and can be driven by at least a human driving force. Examples of the human-powered vehicle include various types of bicycles such as a mountain bike, a road bike, a city bike, a cargo bike, a handcycle, and a recumbent bike. There is no limit to the number of wheels of the human-powered vehicle. The human-powered vehicle also includes, for example, a unicycle or a vehicle having two or more wheels. The human-powered vehicle is not limited to a vehicle that can be driven only by a human driving force. The human-powered vehicle includes an electric bicycle (E-bike) that uses a drive force of an electric motor for propulsion in addition to a human driving force. The E-bike includes an electric assist bicycle that assists in propulsion with an electric motor. In the embodiment described hereafter, the human-powered vehicle will be described as a bicycle.

A human-powered vehicle 10 includes a crank axle 12, a first rotational body 14, a wheel 16, a second rotational body 18, a transmission body 20, and a motor 22. The crank axle 12 is configured to receive a human driving force. The first rotational body 14 is connected to the crank axle 12. The second rotational body 18 is connected to the wheel 16. The transmission body 20 is engaged with the first rotational body 14 and the second rotational body 18 to transmit a driving force between the first rotational body 14 and the second rotational body 18.

The human-powered vehicle 10 further includes, for example, a vehicle body 24. The vehicle body 24 includes, for example, a frame 26. The wheel 16 includes, for example, a front wheel 16F and a rear wheel 16R. The crank axle 12 is, for example, rotatable relative to the frame 26. The human-powered vehicle 10 includes, for example, a crank 28. The crank 28 includes the crank axle 12 and two crank arms 28A and 28B. For example, the crank arm 28A is provided on a first axial end of the crank axle 12, and the crank arm 28B is provided on a second axial end of the crank axle 12. The human-powered vehicle 10 includes, for example, two pedals 30. For example, one of the two pedals 30 is coupled to the crank arm 28A. The other one of the two pedals 30 is coupled to the crank arm 28B. The rear wheel 16R is, for example, driven by rotation of the crank axle 12. The rear wheel 16R is, for example, supported by the frame 26.

The front wheel 16F is attached to the frame 26 by a front fork 32. A handlebar 36 is coupled to the front fork 32 by a stem 34.

The human-powered vehicle 10 further includes, for example, a drive mechanism 38. The drive mechanism 38 connects, for example, the crank 28 and at least one of the front wheel 16F and the rear wheel 16R. In the present embodiment, the drive mechanism 38 connects the crank 28 and the rear wheel 16R.

The drive mechanism 38 includes, for example, at least one first rotational body 14, at least one second rotational body 18, and the transmission body 20. The at least one first rotational body 14 is connected to the crank axle 12. The at least one second rotational body 18 is connected to the wheel 16. The transmission body 20 is engaged with the at least one first rotational body 14 and the at least one second rotational body 18 to transmit driving force between the at least one first rotational body 14 and the at least one second rotational body 18. The transmission body 20 transmits, for example, the rotational force of the at least one first rotational body 14 to the at least one second rotational body 18.

The at least one first rotational body 14 is, for example, arranged coaxially with the crank axle 12. The at least one first rotational body 14 does not have to be arranged coaxially with the crank axle 12. In a case where the at least one first rotational body 14 is not arranged coaxially with the crank axle 12, the at least one first rotational body 14 is, for example, connected to the crank axle 12 by a first transmission mechanism. The first transmission mechanism can include a set of gears, a set of sprockets and a chain, a set of pulleys and a belt, or a set of shafts and bevel gears. The at least one first rotational body 14 includes, for example, at least one first sprocket.

The at least one second rotational body 18 is, for example, arranged coaxially with the rear wheel 16R. The at least one second rotational body 18 does not have to be arranged coaxially with the rear wheel 16R. In a case where the at least one second rotational body 18 is not arranged coaxially with the rear wheel 16R, the at least one second rotational body 18 is, for example, connected to the rear wheel 16R by a second transmission mechanism. The second transmission mechanism can include a set of gears, a set of sprockets and a chain, a set of pulleys and a belt, or a set of shafts and bevel gears. The at least one second rotational body 18 includes, for example, at least one second sprocket.

The at least one second rotational body 18 is connected to the rear wheel 16R by a third one-way clutch. The third one-way clutch includes, for example, at least one of a roller clutch, a sprag clutch, and a ratchet clutch. The third one-way clutch is configured to transmit a driving force from the second rotational body 18 to the rear wheel 16R in a case where the second rotational body 18 is rotated in accordance with a forward rotation of the first rotational body 14. Further, the third one-way clutch is configured to allow relative rotation of the rear wheel 16R and the second rotational body 18 in a case where the speed at which the rear wheel 16R is rotated forward is higher than the speed at which the second rotational body 18 is rotated forward.

The human-powered vehicle 10 further includes, for example, a battery 40. The battery 40 includes one or more battery cells. Each battery cell includes a rechargeable battery. The battery 40 is, for example, configured to supply electric power to the control device 70 and the motor 22. The battery 40 is, for example, connected to the control device 70 in a manner allowing for wired communication or wireless communication. The battery 40 is configured to establish communication with the control device 70 through, for example, power line communication (PLC), Controller Area Network (CAN), or universal asynchronous receiver/transmitter (UART).

The human-powered vehicle 10 further includes, for example, a transmission device 42. The transmission device 42 is, for example, provided in a transmission path of human driving force in the human-powered vehicle 10 and configured to shift a transmission ratio. The transmission ratio is, for example, a ratio of a rotational speed of the wheel 16 to a rotational speed of the crank 28. The rotational speed of the wheel 16 includes, for example, the rotational speed of the drive wheel.

The transmission device 42 includes, for example, at least one of a derailleur 42A and an internal transmission device. The human-powered vehicle 10 of the present embodiment further includes the derailleur 42A. The transmission device 42 of the present embodiment includes the derailleur 42A. The derailleur 42A is configured to operate the transmission body 20 and shift the transmission ratio of the rotational speed of the wheel 16 to a rotational speed of the crank axle 12. The derailleur 42A includes, for example, at least one of a front derailleur and a rear derailleur. In a case where the derailleur 42A includes at least one of a front derailleur and a rear derailleur, the transmission body 20 includes a chain.

The derailleur 42A moves, for example, the transmission body 20 from a position engaged with one of sprockets to a position engaged with another one of the sprockets. In a case where the transmission device 42 includes an internal transmission device, the internal transmission device is, for example, provided in a hub of the rear wheel 16R. The internal transmission device can include a continuously variable transmission (CVT). The transmission device 42 includes, for example, an electric actuator 44. The electric actuator 44 is, for example, configured to actuate the transmission device 42. The electric actuator 44 is, for example, configured to actuate the derailleur 42A.

The derailleur 42A is configured to operate the transmission body 20 and shift the transmission ratio of the rotational speed of the wheel 16 to the rotational speed of the crank axle 12. The derailleur 42A is, for example, provided in the transmission path of human driving force in the human-powered vehicle 10 and configured to shift the transmission ratio. The derailleur 42A shifts the transmission ratio by, for example, operating the transmission body 20 and changing the engagement state of the transmission body 20 and at least one of the at least one first rotational body 14 and the at least one second rotational body 18. The relationship of the transmission ratio, the rotational speed of the wheel 16, and the rotational speed of the crank axle 12 satisfies the following equation (1). In equation (1), the term “R” represents the transmission ratio. In equation (1), the term “W” represents the rotational speed of the wheel 16. In equation (1), the term “C” represents the rotational speed of the crank axle 12.

R=W(rpm)/C(rpm) Equation (1):

The derailleur 42A can shift the transmission ratio, for example, in accordance with at least one transmission stage. The derailleur 42A is, for example, configured to operate the transmission body 20 and shift the at least one transmission stage. The at least one transmission stage is set, for example, in accordance with at least one of the at least one first rotational body 14 and the at least one second rotational body 18. In a case where the at least one transmission stage includes multiple transmission stages, for example, a different transmission ratio is set to each transmission stage. For example, the transmission ratio becomes greater as the transmission stage increases.

In an example in which the at least one first rotational body 14 includes multiple first rotational bodies 14 and the at least one second rotational body 18 includes multiple second rotational bodies 18, the transmission stage is set in accordance with a combination of one of the first rotational bodies 14 and one of the second rotational bodies 18. In an example in which the at least one first rotational body 14 includes one first rotational body 14 and the at least one second rotational body 18 includes multiple second rotational bodies 18, the transmission stage is set in accordance with the number of the second rotational bodies 18. In an example in which the at least one first rotational body 14 includes multiple first rotational bodies 14 and the at least one second rotational body 18 includes one second rotational body 18, the transmission stage is set in accordance with the number of the first rotational bodies 14.

The derailleur 42A moves, for example, the chain from a position engaged with one of the sprockets to a position engaged with another one of the sprockets. The one of the sprockets having the least teeth corresponds to, for example, the smallest transmission stage obtainable by the derailleur 42A. The one of the sprockets having the most teeth corresponds to, for example, the largest transmission stage obtainable by the derailleur 42A.

In a case where the derailleur 42A includes a front derailleur, the first rotational bodies 14 include, for example, two or three first sprockets. The first rotational bodies 14 include, for example, two first sprockets.

In a case where the derailleur 42A includes a front derailleur, the derailleur 42A is, for example, configured to move the transmission body 20 from one of the first rotational bodies 14 to another one of the first rotational bodies 14 in a shifting operation. The front derailleur shifts the transmission ratio by operating the transmission body 20 and changing the engagement state of the transmission body 20 and the at least one first rotational body 14. The first rotational bodies 14 include, for example, first sprockets.

In a case where the derailleur 42A includes a rear derailleur, the at least one second rotational body 18 includes second sprockets and the number of the second sprockets is two or greater and twenty of less. The second rotational bodies 18 include, for example, twelve second sprockets.

The motor 22 is configured to drive the transmission body 20. The motor 22 is, for example, configured to apply a propulsion force to the human-powered vehicle 10 in accordance with a human driving force. The motor 22 includes, for example, one or more electric motors. The electric motor of the motor 22 is, for example, a brushless motor. The motor 22 is, for example, configured to transmit a rotational force to a power transmission path of the human driving force extending from the two pedals 30 to the at least one second rotational body 18. For example, the motor 22 drives the transmission body 20 with the at least one first rotational body 14. In the present embodiment, the motor 22 is provided on the frame 26 of the human-powered vehicle 10, and configured to transmit rotational force to the first rotational body 14.

The human-powered vehicle 10 further includes a housing 46 in which the motor 22 is provided. The motor 22 and the housing 46 form a drive unit 48. The housing 46 is attached to the frame 26. The crank axle 12 is rotatably supported by the housing 46. The motor 22 can be, for example, configured to transmit rotational force to the transmission body 20 without using the at least one first rotational body 14. In a case where the motor 22 is configured to transmit a rotational force to the transmission body 20 without using the at least one first rotational body 14, for example, a sprocket that engages the transmission body 20 is provided on an output shaft of the motor 22 or a transmission member to which the force from the output shaft is transmitted.

The drive unit 48 further includes, for example, an output unit 50. The output unit 50 is, for example, arranged coaxially with the crank axle 12. The output unit 50 is, for example, configured to receive a human driving force and an output of the motor 22. The output unit 50 is, for example, configured to receive the rotational force of the crank axle 12 and an output of the motor 22. The output unit 50 is, for example, cylindrical. The output unit 50 is, for example, provided on an outer circumferential portion of the crank axle 12 about the rotational axis. The at least one first rotational body 14 is coupled to, for example, a first end 50A of the output unit 50 in a manner rotatable integrally with the output unit 50.

The drive unit 48 includes, for example, a speed reducer 52. The speed reducer 52 is, for example, provided between the motor 22 and the power transmission path of human driving force. The speed reducer 52 includes, for example, at least one speed reducing unit. The at least one speed reducing unit includes, for example, a first speed reducing unit 52A, a second speed reducing unit 52B, and a third speed reducing unit 52C. The number of speed reducing units included in the speed reducer 52 can be one, two, four or more.

The first speed reducing unit 52A receives, for example, the rotational torque of the motor 22. The first speed reducing unit 52A includes, for example, two gears meshed with each other. The first speed reducing unit 52A can include a belt and pulleys instead of the gears. The first speed reducing unit 52A can include a chain and sprockets instead of the gears.

The second speed reducing unit 52B receives, for example, the rotational torque of the motor 22 via the first speed reducing unit 52A. The second speed reducing unit 52B includes, for example, two gears meshed with each other. The second speed reducing unit 52B can include a belt and pulleys instead of the gears. The second speed reducing unit 52B can include a chain and sprockets instead of the gears.

The third speed reducing unit 52C receives, for example, the rotational torque of the motor 22 via the second speed reducing unit 52B. The third speed reducing unit 52C transmits the rotational torque of the motor 22 to, for example, the output unit 50. The third speed reducing unit 52C includes, for example, two gears meshed with each other. The third speed reducing unit 52C can include a belt and pulleys instead of the gears. The third speed reducing unit 52C can include a chain and sprockets instead of the gears.

The drive unit 48 further includes, for example, a first one-way clutch 54. The first one-way clutch 54 is, for example, provided in a power transmission path from the crank axle 12 to at least one first rotational body 14. The first one-way clutch 54 is provided, for example, between the crank axle 12 and the output unit 50.

The first one-way clutch 54 is, for example, configured to rotate the first rotational body 14 forward in a case where the crank axle 12 is rotated forward and allow relative rotation of the crank axle 12 and the at least one first rotational body 14 in a case where the crank axle 12 is rotated rearward. The first one-way clutch 54 includes, for example, at least one of a roller clutch, a sprag clutch, and a ratchet clutch.

The drive unit 48 further includes, for example, a second one-way clutch 56. The second one-way clutch 56 is provided, for example, in a power transmission path from the motor 22 to the at least one first rotational body 14. The second one-way clutch 56 is, for example, provided on the speed reducer 52.

The second one-way clutch 56 is, for example, configured to transmit the rotational force of the motor 22 to the output unit 50. The second one-way clutch 56 is, for example, configured to restrict transmission of the rotational force of the crank axle 12 to the motor 22 in a case where the crank axle 12 is rotated forward. The second one-way clutch 56 includes, for example, at least one of a roller clutch, a sprag clutch, and a ratchet clutch.

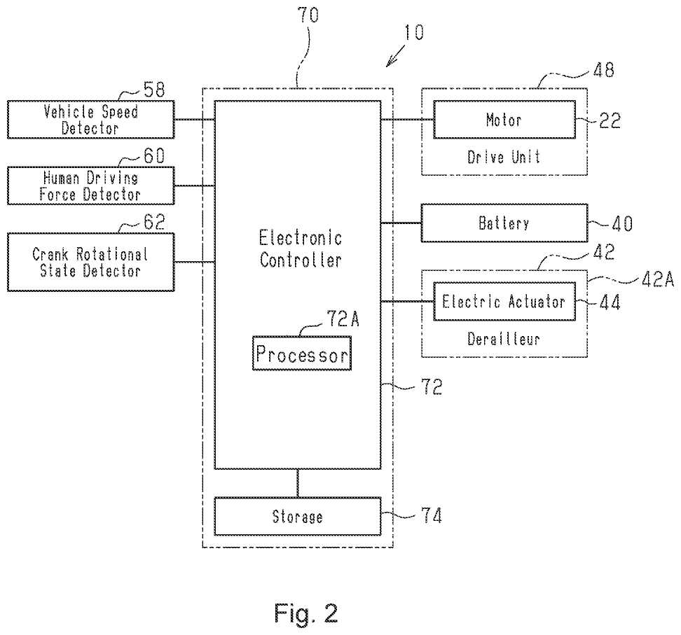

As seen in FIG. 2, the human-powered vehicle 10 further includes one or more detectors for detecting an operating condition of the human-powered vehicle 10. The term “detector” as used herein refers to a hardware device or instrument designed to detect the presence or absence of a particular event, object, substance, or a change in its environment, and to emit a signal in response. The term “detector” as used herein do not include a human being.

As seen in FIG. 2, the human-powered vehicle 10 further includes an electronic controller 72 configured to control the motor 22. The electronic controller 72 is configured to receive input signals from the detectors. In this way, the electronic controller 72 can control the motor 22 based on a human-powered vehicle condition detected by one or more of the detectors.

The human-powered vehicle 10 further includes, for example, a vehicle speed detector 58. The vehicle speed detector 58 is, for example, connected to the electronic controller 72 in a manner allowing for wired communication or wireless communication. The vehicle speed detector 58 is configured to detect, for example, information related to a speed of the human-powered vehicle 10. The vehicle speed detector 58 is configured to detect, for example, information related to the rotational speed of the wheel 16. The vehicle speed detector 58 is configured to detect, for example, a magnet provided on at least one of the front wheel 16F and the rear wheel 16R.

The vehicle speed detector 58 is, for example, configured to output a predetermined number of detection signals during a period in which the wheel 16 completes one rotation. The predetermined number is, for example, one. The vehicle speed detector 58 outputs, for example, a signal corresponding to the rotational speed of the wheel 16. The electronic controller 72 can calculate the speed of the human-powered vehicle 10 based on the signal corresponding to the rotational speed of the wheel 16 and information related to the circumferential length of the wheel 16. The information related to the circumferential length of the wheel 16 is stored in storage 74.

The human-powered vehicle 10 further includes, for example, a human driving force detector 60. The human driving force detector 60 is connected to the electronic controller 72 in a manner allowing for wired communication or wireless communication. The human driving force detector 60 is configured to output a signal corresponding to the torque applied to the crank axle 12 by a human driving force. The signal corresponding to the torque applied to the crank axle 12 by the human driving force includes information related to the human driving force input to the human-powered vehicle 10.

The human driving force detector 60 is provided on, for example, a member included in the transmission path of the human driving force or a member near the member included in the transmission path of the human driving force. The member included in the transmission path of human driving force includes, for example, the crank axle 12 and a member that transmits human driving force between the crank axle 12 and the at least one first rotational body 14. The human driving force detector 60 is provided on, for example, a power transmission portion configured to transmit the human driving force from the crank axle 12 to the output unit 50. The power transmission portion is provided on, for example, the outer circumferential portion of the crank axle 12.

The human driving force detector 60 includes a strain sensor, a magnetostrictive sensor, a pressure sensor, or the like. A strain sensor includes a strain gauge. The human driving force detector 60 can have any configuration as long as information related to the human driving force is obtained.

The human driving force detector 60 can be provided on, for example, at least one of the crank arms 28A and 28B or at least one of the two pedals 30. In a case where the human driving force detector 60 is provided on at least one of the two pedals 30, the human driving force detector 60 can include, for example, a sensor that detects the pressure applied to the at least one of the two pedals 30. The human driving force detector 60 can be provided on, for example, the chain included in the transmission body 20. In a case where the human driving force detector 60 is provided on the chain, the human driving force detector 60 can include, for example, a sensor that detects the tension on the chain.

The human-powered vehicle 10 further includes, for example, a crank rotational state detector 62. The crank rotational state detector 62 is, for example, connected to the electronic controller 72 in a manner allowing for wired communication or wireless communication. The crank rotational state detector 62 detects a rotational amount of at least one of the crank axle 12 and the at least one first rotational body 14. The crank rotational state detector 62 is configured to detect, for example, information corresponding to the rotational speed of the crank axle 12. The crank rotational state detector 62 is configured to detect, for example, information corresponding to a rotational speed of the at least one first rotational body 14. The information corresponding to the rotational speed of the crank axle 12 includes angular acceleration of the crank axle 12. The information corresponding to the rotational speed of the at least one first rotational body 14 includes angular acceleration of the at least one first rotational body 14.

The crank rotational state detector 62 includes, for example, a magnetic sensor that outputs a signal corresponding to the strength of a magnetic field. The crank rotational state detector 62 includes a ring-shaped magnet having magnetic poles arranged in a circumferential direction. The ring-shaped magnet is provided on, for example, the crank axle 12, the at least one first rotational body 14, or the power transmission path between the crank axle 12 and the first rotational body 14. The ring-shaped magnet includes, for example, one S-pole and one N-pole. Each of the S-pole and the N-pole continuously extends over 180° about the axis of the crank axle 12.

The crank rotational state detector 62 outputs, for example, a signal corresponding to at least one of the rotational speed of the crank axle 12 and the rotational speed of the at least one first rotational body 14. The crank rotational state detector 62 is, for example, configured to output a detection signal corresponding to a rotational angle of the crank axle 12 during a period in which at least one of the crank axle 12 and the at least one first rotational body 14 completes one rotation. Instead of the magnetic sensor, the crank rotational state detector 62 can include an optical sensor, an acceleration sensor, a gyro sensor, a torque sensor, or the like.

The crank rotational state detector 62 is provided on, for example, the frame 26 of the human-powered vehicle 10. In a case where the crank rotational state detector 62 is provided on the frame 26, the crank rotational state detector 62 can include, for example, a vehicle speed sensor. In a case where the crank rotational state detector 62 includes a vehicle speed sensor, the electronic controller 72 can be configured to calculate the rotational speed of the crank axle 12 in accordance with the speed detected by the vehicle speed sensor and the transmission ratio. The crank rotational state detector 62 can be provided on, for example, the drive unit 48.

The crank rotational state detector 62 can be configured to detect a rotational amount of the second rotational body 18. The crank rotational state detector 62 can be configured to detect information corresponding to a rotational speed of the at least one second rotational body 18. The information corresponding to the rotational speed of the at least one second rotational body 18 includes, for example, angular acceleration of the at least one second rotational body 18. The crank rotational state detector 62 can output, for example, a signal corresponding to the rotational speed of the at least one second rotational body 18.

As mentioned above, the human-powered vehicle control device 70 includes the electronic controller 72. The electronic controller 72 includes, for example, one or more processors 72A that execute predetermined control programs. Each of the processors 72A of the electronic controller 72 includes, for example, a central processing unit (CPU) or a micro-processing unit (MPU).

The processors 72A of the electronic controller 72 can be located at, for example, separate positions. For example, some of the processors 72A can be located on the human-powered vehicle 10, and the other processors 72A can be located in a server connected to the internet. In a case where the processors are located at separate positions, the processors are connected to one another via a wireless communication device in a manner allowing for communication. The electronic controller 72 can include one or more microcomputers. The electronic controller 72 is formed of one or more semiconductor chips that are mounted on a circuit board. Thus, the terms “electronic controller” and “controller” as used herein refers to hardware that executes a software program, and does not include a human being.

The control device 70 further includes, for example, the storage 74. The storage 74 is any computer storage device or any non-transitory computer-readable medium with the sole exception of a transitory, propagating signal. The storage 74 is, for example, connected to the electronic controller 72 in a manner allowing for wired communication or wireless communication. The storage 74 stores, for example, control programs and information used for control processes. The electronic storage 74 includes, for example, a non-volatile memory and a volatile memory. The non-volatile memory includes, for example, at least one of a read-only memory (ROM), an erasable programmable read-only memory (EPROM), an electrically erasable programmable read-only memory (EEPROM), and a flash memory. The volatile memory includes, for example, a random-access memory (RAM).

The control device 70 can further include, for example, a drive circuit of the motor 22. The electronic controller 72 and the drive circuit are provided on, for example, the housing 46. The electronic controller 72 and the drive circuit can be provided on the same circuit board. The drive circuit is, for example, connected to the electronic controller 72 in a manner allowing for wired communication or wireless communication. The drive circuit drives the motor 22, for example, in response to a control signal from the electronic controller 72.

The drive circuit is, for example, electrically connected to the motor 22. The drive circuit controls, for example, the supply of electric power from the battery 40 to the motor 22. The drive circuit includes, for example, an inverter circuit. The inverter circuit includes, for example, transistors. For example, the inverter circuit has a configuration in which inverter units are connected in parallel and each inverter unit is formed by two transistors connected in series. The inverter circuit can include, for example, a current sensor that detects the current flowing through the inverter circuit. The current sensor is, for example, connected to the electronic controller 72 in a manner allowing for wired communication or wireless communication.

The electronic controller 72 is configured to control the motor 22. The electronic controller 72 is, for example, configured to control the motor 22 in accordance with a state of the human-powered vehicle 10. The electronic controller 72 is, for example, configured to control the motor 22 so that propulsion force changes in accordance with the human driving force input to the human-powered vehicle 10. The electronic controller 72 is, for example, configured to control the motor 22 in accordance with the human driving force detected by the human driving force detector 60.

The electronic controller 72 is, for example, configured to control the motor 22 in accordance with at least one of the rotational speed of the crank axle 12 and the rotational speed of the at least one first rotational body 14 detected by the crank rotational state detector 62. The electronic controller 72 is, for example, configured to control the motor 22 in accordance with the speed of the human-powered vehicle 10 detected by the vehicle speed detector 58. In a case where the speed of the human-powered vehicle 10 is less than or equal to a predetermined first speed, the electronic controller 72 is configured to drive the motor 22 so as to apply propulsion force to the human-powered vehicle 10 in accordance with at least one of the human driving force and the rotational speed of the crank axle 12. The predetermined first speed is, for example, set by regulations. The predetermined first speed is, for example, 25 km/h or 27.5 km/h.

The electronic controller 72 can be configured to drive the motor 22 in accordance with information transmitted from outside the drive unit 48. The information transmitted from outside the drive unit 48 can include an operation signal of an assist operating device that is operable by a user.

The electronic controller 72 is, for example, configured to control the motor 22 so that an assist level of the motor 22 becomes a predetermined assist level. The assist level includes, for example, at least one of a ratio of the output of the motor 22 to the human driving force input to the human-powered vehicle 10, the maximum value of the output of the motor 22, and a restriction level that restricts changes in the output of the motor 22 in a case where the output of the motor 22 decreases.

The electronic controller 72 is, for example, configured to control the motor 22 so that a ratio of assist force to human driving force becomes a predetermined ratio. The human driving force corresponds to, for example, the propulsion force of the human-powered vehicle 10 produced by the user rotating the crank axle 12. The human driving force corresponds to, for example, the driving force input to the first rotational body 14 by the user rotating the crank axle 12.

The assist force includes, for example, the driving force input to the first rotational body 14 in accordance with the output of the motor 22. The assist force corresponds to, for example, the propulsion force of the human-powered vehicle 10 produced by the rotation of the motor 22. In a case where the drive unit 48 includes the speed reducer 52, the assist force corresponds to, for example, the output of the speed reducer 52.

The predetermined ratio does not have to be set constant and can be varied in accordance with human driving force. The predetermined ratio does not have to be set constant and can be varied in accordance with at least one of the rotational speed of the crank axle 12 and the rotational speed of the at least one first rotational body 14. The predetermined ratio does not have to be set constant and can be varied in accordance with the speed of the human-powered vehicle 10. The predetermined ratio does not have to be set constant and can be varied in accordance with any two of the human driving force, the vehicle speed, and at least one of the rotational speed of the crank axle 12 and the rotational speed of the at least one first rotational body 14. Alternatively, the predetermined ratio can be varied in accordance with every one of the vehicle speed, the human driving force, the rotational speed of the crank axle 12, and the rotational speed of the at least one first rotational body 14.

The human driving force is, for example, expressed as at least one of torque and power. In a case where human driving force is expressed as torque, the human driving force is referred to as, for example, human torque. The power of human driving force is, for example, the product of the torque applied to the crank axle 12 and the rotational speed of the crank axle 12.

The assist force is, for example, expressed as at least one of torque and power. In a case where the assist force is expressed as torque, the assist force is referred to as, for example, assist torque. In a case where the assist force is expressed as power, the assist force is referred to as, for example, assist power. The assist power is, for example, the product of the output torque of the speed reducer 52 and a rotational speed of an output shaft of the speed reducer 52. The ratio of assist force to human driving force can be, for example, a ratio of assist torque to human torque or a ratio of assist power to human force based power.

The electronic controller 72 is, for example, configured to control the motor 22 so that the assist force becomes less than or equal to the maximum assist force. The electronic controller 72 is, for example, configured to control the motor 22 so that the assist torque becomes less than or equal to the maximum assist torque. The maximum assist torque is a value, for example, in a range from 20 Nm or greater and 200 Nm or less. The maximum assist torque is determined by, for example, at least one of an output characteristic and a control mode of the motor 22. The electronic controller 72 can be configured to control the motor 22 so that the assist power becomes less than or equal to the maximum assist power.

The electronic controller 72 is, for example, configured to control the derailleur 42A. The electronic controller 72 is configured to control the derailleur 42A, for example, in response to a shifting instruction. The shifting instruction corresponds to, for example, at least one of a shifting condition and an output from a shifting device that is operable by the user. The shifting instruction includes, for example, a shifting instruction for increasing the transmission ratio and a shifting instruction for decreasing the transmission ratio. The shifting condition is related to, for example, at least one of a traveling environment and a traveling state of the human-powered vehicle 10. The traveling environment of the human-powered vehicle 10 includes, for example, at least one of gradient and traveling resistance of a road surface. The traveling state of the human-powered vehicle 10 includes, for example, a vehicle speed, a rotational speed of the crank axle 12, a human driving force, and an inclination angle of the human-powered vehicle 10.

In a case where a predetermined condition is satisfied, the electronic controller 72 is configured to control the motor 22 so that the motor 22 drives the transmission body 20. In a case where the predetermined condition is satisfied, the electronic controller 72 is configured to control the motor 22 so that a driving condition of the motor 22 is satisfied. The driving condition of the motor 22 includes, for example, a condition for driving the motor 22 without propelling the human-powered vehicle 10 with the motor 22. The driving condition of the motor 22 includes, for example, a condition for driving the motor 22 without rotating the wheel 16 with the motor 22 in a state in which the wheel 16 of the human-powered vehicle 10 is contacting the ground and the human-powered vehicle 10 is not moving. In a case where the predetermined condition is satisfied, for example, the electronic controller 72 drives the motor 22 without rotating the wheel 16 so as to drive the transmission body 20 in a manner allowing for shifting by the derailleur 42A.

The predetermined condition includes a first condition in which rotation of the crank axle 12 is stopped. The first condition is, for example, a condition allowing for determination that a rider stops pedaling. A state in which rotation of the crank axle 12 is stopped includes, for example, a state in which the rotational speed of the crank axle 12 is less than or equal to a predetermined rotational speed. The electronic controller 72 is, for example, configured to determine that rotation of the crank axle 12 is stopped in a case where the rotational speed of the crank axle 12 is less than or equal to the predetermined rotational speed. The electronic controller 72 determines that the first condition is satisfied, for example, in a case where the rotational speed of the crank axle 12 is less than or equal to the predetermined rotational speed. The predetermined rotational speed is, for example, 0 rpm or greater and 5 rpm or less. The predetermined rotational speed is, for example, 3 rpm. The predetermined rotational speed can be greater than 0 rpm. The predetermined rotational speed can be set based on the rotational speed at which the crank axle 12 rotates back and forth in a case where the rider stops pedaling. The electronic controller 72 can be configured to determine that rotation of the crank axle 12 is stopped in a case where the human driving force is less than or equal to a stopping determination driving force. The stopping determination driving force corresponds to, for example, human torque that is 1 Nm or greater and 5 Nm or less.

The predetermined condition further includes a second condition in which the derailleur 42A operates the transmission body 20 to shift the transmission ratio. The second condition corresponds to, for example, the shifting instruction. The electronic controller 72 determines that the second condition is satisfied, for example, in a case where a shifting instruction is generated.

The predetermined condition further includes, for example, a third condition in which the wheel 16 is rotating. The electronic controller 72 is configured to determine that the wheel 16 is rotating in a case where the vehicle speed is greater than or equal to a predetermined speed. The electronic controller 72 determines that the third condition is satisfied, for example, in a case where the vehicle speed is greater than or equal to the predetermined speed.

The predetermined condition includes, for example, a fourth condition in which the first condition is satisfied after a condition is satisfied in which the human driving force received by the crank axle 12 is greater than or equal to a predetermined driving force. The fourth condition is, for example, a condition allowing for determination that the rider is riding the human-powered vehicle 10. The predetermined human driving force is set, for example, based on the human driving force detected by the human driving force detector 60 in a case where one uses his or her hand to rotate the crank axle 12 in a state in which the wheel 16 of the human-powered vehicle 10 is lifted from the ground. The predetermined human driving force is, for example, greater than the stopping determination driving force. The predetermined human driving force can be less than or equal to the stopping determination driving force. The predetermined human driving force corresponds to, for example, the torque in a case where human torque is in a range from 5 Nm or greater to 40 Nm or less.

The electronic controller 72 determines that the fourth condition is satisfied, for example, in a case where the first condition is satisfied within a predetermined period after the condition is satisfied in which the human driving force received by the crank axle 12 is greater than or equal to the predetermined driving force. The electronic controller 72 determines that the fourth condition is satisfied, for example, in a case where the first condition is satisfied after a driving force greater than or equal to the predetermined driving force is detected more than once. The electronic controller 72 determines that the fourth condition is satisfied, for example, in a case where the first condition is satisfied after the repetition of a state in which a driving force is greater than or equal to the predetermined driving force and a state in which a driving force is less than the predetermined driving force is detected more than once.

If the predetermined condition includes every one of the first to fourth conditions, the electronic controller 72 determines that the predetermined condition is satisfied, for example, in a case where a shifting instruction is generated in a case where the rider rides the traveling human-powered vehicle 10 and the rotational speed of the crank axle 12 is less than or equal to the predetermined rotational speed. If a shifting instruction is generated in a case where the rider rides the traveling human-powered vehicle 10 and rotation of the crank axle 12 is stopped, the electronic controller 72 is, for example, configured to drive the motor 22 and control the derailleur 42A in response to the shifting instruction.

A case where a shifting instruction is generated in a state in which the rider is riding the traveling human-powered vehicle 10 and rotation of the crank axle 12 is stopped includes, for example, a case where the transmission ratio is set to less than or equal to a predetermined transmission ratio in accordance with a decrease in the vehicle speed. A case where a shifting instruction is generated in a state in which the rider is riding the traveling human-powered vehicle 10 and rotation of the crank axle 12 is stopped includes, for example, a case where the rider operates the shifting device in a state in which pedaling by the rider is stopped.

The driving condition of the motor 22 includes at least one of a first driving condition and a second driving condition. In a case where the predetermined condition is satisfied, the electronic controller 72 is, for example, configured to control the motor 22 so that both of the first driving condition and the second driving condition are satisfied.

The first driving condition includes a condition in which the motor 22 is driven so that the rotational torque of the first rotational body 14 produced by the motor 22 is kept less than or equal to a predetermined torque. In a case where the predetermined condition is satisfied, the electronic controller 72 is, for example, configured to drive the motor 22 so that the rotational torque of the first rotational body 14 produced by the motor 22 is kept less than or equal to the predetermined torque. The predetermined torque is 1 Nm or greater and 10 Nm or less. The predetermined torque is, for example, 2 Nm or greater and 10 Nm or less. The predetermined torque is, for example, torque at which the wheel 16 is not rotated by driving of the motor 22 in a state in which the wheel 16 of the human-powered vehicle 10 is contacting the ground and the human-powered vehicle 10 is not moving.

The predetermined torque is set, for example, in accordance with the transmission ratio of the human-powered vehicle 10. The predetermined torque can be set constant regardless of the transmission ratio. If the predetermined torque is set in accordance with the transmission ratio of the human-powered vehicle 10, for example, a predetermined torque in a case where the transmission ratio is less than or equal to a predetermined transmission ratio can differ from a predetermined torque in a case where the transmission ratio is greater than the predetermined transmission ratio. The predetermined torque in a case where the transmission ratio is less than or equal to the predetermined transmission ratio is, for example, 2 Nm. The predetermined torque in a case where the transmission ratio is greater than the predetermined transmission ratio is, for example, 5 Nm. The predetermined torque can be set in three or more stages in accordance with the transmission ratio. The predetermined torque can be set to increase as the transmission ratio decreases. The predetermined torque can be set to decrease as the transmission ratio decreases.

The second driving condition includes a condition in which the electronic controller 72 drives the transmission body 20 by driving the motor 22 at a predetermined current value or less. In a case where the predetermined condition is satisfied, the electronic controller 72 is, for example, configured to drive the transmission body 20 by driving the motor 22 at the predetermined current value or less. The predetermined current value is greater than a standby current value of the motor 22 and less than or equal to 5 A (amperes). The predetermined current value is, for example, 2 A (amperes) or less. The predetermined current value is, for example, 1.5 A (amperes) or less. The predetermined current value is, for example, 1.2 A(amperes). The predetermined current value is, for example, 1 A(amperes). The standby current value is, for example, a current value in a state in which no load is applied to the motor 22.

The electronic controller 72 is, for example, configured to drive the motor 22 so that the rotational speed of the first rotational body 14 becomes less than or equal to an estimated rotational speed. The estimated rotational speed is calculated from the transmission ratio of the human-powered vehicle 10 and the speed of the human-powered vehicle 10. In a case where the predetermined condition is satisfied, the electronic controller 72 is, for example, configured to drive the motor 22 so that the rotational speed of the first rotational body 14 becomes less than or equal to the estimated rotational speed. In a case where the crank axle 12 is not rotated in a state in which the wheel 16 is rotating, the estimated rotational speed becomes greater than or equal to the actual rotational speed of the crank axle 12. The estimated rotational speed is, for example, calculated by equation (2). In equation (2), the term “CX” represents the estimated rotational speed. In equation (2), “V” represents the vehicle speed. In equation (2), the term “R” represents the transmission ratio. In expression (2), the term “L” represents the circumferential length of the wheel 16.

CX(rpm)=[V(km/h)×1000]/[R×60×L(m)] Equation (2):

The electronic controller 72 is, for example, configured so as not to actuate the derailleur 42A if the speed of the human-powered vehicle 10 is in a predetermined speed range including the predetermined first speed in a case where the predetermined condition is satisfied. The predetermined speed range can be, for example, a range from 20 km/h or greater to 30 km/h or less or a range from 22 km/h or greater to 28 km/h or less. In a case where the second condition is satisfied in a state in which the vehicle speed is outside the predetermined speed range including the predetermined first speed, the electronic controller 72 is, for example, configured to drive the motor 22 so as to actuate the derailleur 42A and drive the transmission body 20. In a case where the predetermined condition is satisfied in a state in which the vehicle speed is higher than the predetermined first speed, the electronic controller 72 is, for example, configured so as not to actuate the derailleur 42A or drive the motor 22.

In a case where the predetermined condition is satisfied, the electronic controller 72 is, for example, configured to stop driving the motor 22 in accordance with a load on the motor 22. In a case where the electronic controller 72 starts driving the motor 22 as the predetermined condition is satisfied and the load on the motor 22 then becomes greater than or equal to a predetermined load, the electronic controller 72 is, for example, configured to stop driving the motor 22. The predetermined load is, for example, set to a value allowing for determination that a foreign object or the like has been caught in at least one of the transmission body 20, the first rotational body 14, and the second rotational body 18.

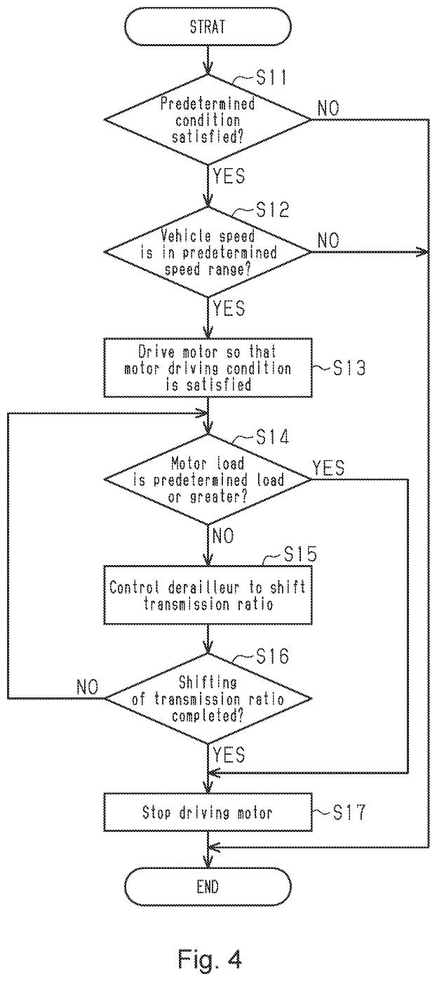

A process executed by the electronic controller 72 to control the motor 22 and the derailleur 42A will now be described with reference to FIG. 4. For example, in a case where electric power is supplied to the electronic controller 72, the electronic controller 72 starts the process of the flowchart shown in FIG. 4 from step S11. In a case where the process of the flowchart shown in FIG. 4 ends, the electronic controller 72 repeats the process from step S11 in predetermined cycles until, for example, the supply of electric power stops.

In step S11, the electronic controller 72 determines whether the predetermined condition is satisfied. In a case where the predetermined condition is not satisfied, the electronic controller 72 ends processing. In a case where the predetermined condition has been satisfied, the electronic controller 72 proceeds to step S12.

In step S12, the electronic controller 72 determines whether the vehicle speed is in the predetermined speed range. In a case where the vehicle speed is not in the predetermined speed range, the electronic controller 72 ends processing. In a case where the vehicle speed is in the predetermined speed range, the electronic controller 72 proceeds to step S13.

In step S13, the electronic controller 72 drives the motor 22 so that the driving condition of the motor 22 is satisfied and then proceeds to step S14. In step S14, the electronic controller 72 determines whether the load on the motor 22 is greater than or equal to the predetermined load. In a case where the load on the motor 22 is not greater than or equal to the predetermined load, the electronic controller 72 proceeds to step S15. In a case where the load on the motor 22 is greater than or equal to the predetermined load, the electronic controller 72 proceeds to step S17.

In step S15, the electronic controller 72 controls the derailleur 42A to shift the transmission ratio and then proceeds to step S16. In step S16, the electronic controller 72 determines whether shifting of the transmission ratio is completed. In a case where shifting of the transmission ratio is not completed, the electronic controller 72 proceeds to step S14. In a case where shifting of the transmission ratio has been completed, the electronic controller 72 proceeds to step S17. The electronic controller 72 determines that shifting of the transmission ratio is completed in step S16, for example, in a case where a predetermined shifting period elapses from when shifting of the transmission ratio is started. Step S16 can be omitted. In a case where step S16 is omitted, the electronic controller 72 proceeds from step S15 to step S17.

In step S17, the electronic controller 72 stops driving the motor 22 and then ends processing. In a case where the human driving force becomes greater than a first driving force during the process shown in FIG. 4, the electronic controller 72 can be configured to drive the motor 22 in a manner allowing for propulsion of the human-powered vehicle 10 with the motor 22.

Step S12 can be omitted from the process shown in FIG. 4. In a case where step S12 is omitted and an affirmative determination is given in step S11, the electronic controller 72 proceeds to step S13. Step S14 can be omitted from the process shown in FIG. 4. In a case where step S14 is omitted, the electronic controller 72 proceeds to step S15 after step S13. In a case where step S14 is omitted and a negative determination is given in step S16, the electronic controller 72 proceeds to step S15.

Modifications

The description related with the above embodiment exemplifies, without any intention to limit, an applicable form of a human-powered vehicle control device according to the present disclosure. In addition to the embodiment described above, the human-powered vehicle control device according to the present disclosure is applicable to, for example, modified examples of the above embodiment that are described below and combinations of at least two of the modified examples that do not contradict each other. In the modified examples described hereafter, same reference numerals are given to those components that are the same as the corresponding components of the above embodiment and such components will not be described in detail.

The electronic controller 72 can be configured not to control the derailleur 42A. In a case where the electronic controller 72 is configured not to control the derailleur 42A, for example, the electronic controller 72 can determine whether the second condition is satisfied based on a signal received from the shifting device. In a case where the electronic controller 72 is configured not to control the derailleur 42A, the derailleur 42A can be a manually-operated derailleur that does not include the electric actuator 44.

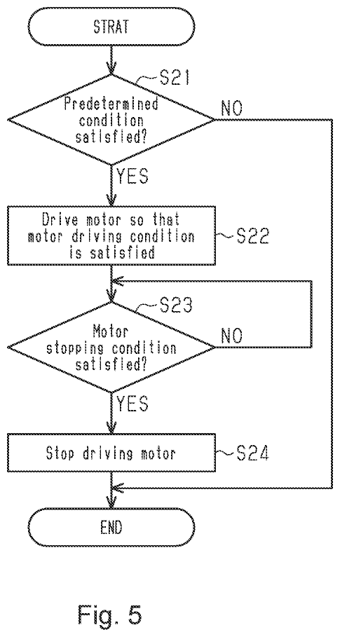

A process executed by the electronic controller 72 to control the motor 22 without controlling the derailleur 42A will now be described with reference to FIG. 5. For example, in a case where electric power is supplied to the electronic controller 72, the electronic controller 72 starts the process of the flowchart shown in FIG. 5 from step S21. In a case where the process of the flowchart shown in FIG. 5 ends, the electronic controller 72 repeats the process from step S21 in predetermined cycles until, for example, the supply of electric power stops.

In step S21, the electronic controller 72 determines whether the predetermined condition is satisfied. In a case where the predetermined condition is not satisfied, the electronic controller 72 ends processing. In a case where the predetermined condition has been satisfied, electronic the controller 72 proceeds to step S22.

In step S22, the electronic controller 72 drives the motor 22 so that the driving condition of the motor 22 is satisfied and then proceeds to step S23. In step S23, the electronic controller 72 determines whether a motor stopping condition is satisfied. In a case where the motor stopping condition is not satisfied, the electronic controller 72 executes step S23 again. In a case where the motor stopping condition has been satisfied, the electronic controller 72 proceeds to step S24. The motor stopping condition is satisfied, for example, in a case where a predetermined period elapses from when driving of the motor 22 is started. The predetermined period includes, for example, a period from when driving of the motor 22 is started to when the travel distance of the human-powered vehicle 10 reaches a predetermined distance. The predetermined distance is, for example, set by regulations. The predetermined distance is, for example, 2 m. The motor stopping condition can be satisfied, for example, in a case where the load on the motor 22 is greater than or equal to the predetermined load.

In step S24, the electronic controller 72 stops driving the motor 22 and then ends processing. In a case where the human driving force becomes greater than a first driving force during the process shown in FIG. 5, the electronic controller 72 can be configured to drive the motor 22 in accordance with at least one of the human driving force and the rotational speed of the crank axle 12 in a manner allowing for propulsion of the human-powered vehicle 10 with the motor 22.

In a case where the derailleur 42A is a manually-operated derailleur that does not include the electric actuator 44, the predetermined first speed can differ from that in a case where the derailleur 42A includes the electric actuator 44. The manually-operated derailleur is, for example, connected to the shifting device by a Bowden cable. In a case where the derailleur 42A is a manually-operated derailleur that does not include the electric actuator 44, the predetermined first speed is, for example, higher than that in a case where the derailleur 42A includes the electric actuator 44.

In a case where the human-powered vehicle 10 is coasting, the electronic controller 72 can be configured to determine that the predetermined condition is continuously satisfied. A coasting state includes, for example, a state in which the wheel 16 is rotating and the estimated rotational speed of the crank axle 12 is less than or equal to the rotational speed of the crank axle 12 detected by the crank rotational state detector 62.

In a case where rotation of the crank axle 12 is stopped, the electronic controller 72 can be configured to determine that the predetermined condition is continuously satisfied regardless of the traveling state of the human-powered vehicle 10. In a case where rotation of the crank axle 12 is stopped, the electronic controller 72 can continuously drive the motor 22 regardless of the traveling state of the human-powered vehicle 10.

In a case where the predetermined condition is satisfied, the electronic controller 72 can be configured so as not to drive the motor 22 if the air pressure of a tire is in a predetermined range from an initial value to a predetermined value. The predetermined range is used for determination of a state in which the rider is not riding the human-powered vehicle 10. The electronic controller 72 is, for example, configured to obtain the initial value from an output of a detector that detects the air pressure of the tire. The initial value is, for example, the air pressure of the tire in a case where the rider is not riding the human-powered vehicle 10.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three.

What is claimed is:

1. A control device for a human-powered vehicle including a crank axle configured to receive a human driving force, a first rotational body connected to the crank axle, a wheel, a second rotational body connected to the wheel, a transmission body engaged with the first rotational body and the second rotational body to transmit a driving force between the first rotational body and the second rotational body, and a motor configured to drive the transmission body, the control device comprising:
an electronic controller configured to control the motor,
in a case where a predetermined condition is satisfied, the electronic controller is configured to drive the motor so that a rotational torque of the first rotational body produced by the motor is kept less than or equal to a predetermined torque,
the predetermined condition includes a first condition in which rotation of the crank axle is stopped, and
the predetermined torque is 1 Nm or greater and 10 Nm or less.

2. The control device according to claim 1, wherein
the predetermined torque is 2 Nm or greater and 10 Nm or less.

3. The control device according to claim 1, wherein
the predetermined torque is set in accordance with a transmission ratio of the human-powered vehicle.

4. The control device according to claim 1, wherein
the human-powered vehicle further includes a derailleur configured to operate the transmission body and shift a transmission ratio of a rotational speed of the wheel to a rotational speed of the crank axle; and
the predetermined condition further includes a second condition in which the derailleur operates the transmission body to shift the transmission ratio.

5. The control device according to claim 4, wherein:
in a case where a speed of the human-powered vehicle is less than or equal to a predetermined first speed, the electronic controller is configured to drive the motor so as to apply a propulsion force to the human-powered vehicle in accordance with at least one of the human driving force and the rotational speed of the crank axle;
the electronic controller is configured to control the derailleur; and
the electronic controller is configured so as not to actuate the derailleur upon determining the speed of the human-powered vehicle is in a predetermined speed range including the predetermined first speed in a case where the predetermined condition is satisfied.

6. The control device according to claim 1, wherein
the predetermined condition further includes a third condition in which the wheel is rotating.

7. The control device according to claim 1, wherein
the electronic controller is configured to determine that rotation of the crank axle is stopped in a case where a rotational speed of the crank axle is less than or equal to a predetermined rotational speed.

8. The control device according to claim 1, wherein
the electronic controller is configured to drive the motor so that a rotational speed of the first rotational body becomes less than or equal to an estimated rotational speed; and
the estimated rotational speed is calculated from a transmission ratio of the human-powered vehicle and a speed of the human-powered vehicle.

9. The control device according to claim 1, wherein
in a case where the predetermined condition is satisfied, the electronic controller is configured to stop driving the motor in accordance with a load on the motor.

10. The control device according to claim 9, wherein
in a case where the electronic controller starts driving the motor as the predetermined condition is satisfied and the load on the motor then becomes greater than or equal to a predetermined load, the electronic controller is configured to stop driving the motor.

11. The control device according to claim 1, wherein
the predetermined condition includes a fourth condition in which the first condition is satisfied after a condition is satisfied in which the human driving force received by the crank axle is greater than or equal to a predetermined driving force.

12. A control device for a human-powered vehicle including a crank axle configured to receive a human driving force, a first rotational body connected to the crank axle, a wheel, a second rotational body connected to the wheel, a transmission body engaged with the first rotational body and the second rotational body to transmit a driving force between the first rotational body and the second rotational body, and a motor configured to drive the transmission body, the control device comprising:
an electronic controller, wherein
the electronic controller is configured to control the motor,
in a case where a predetermined condition is satisfied, the electronic controller is configured to drive the transmission body by driving the motor at a predetermined current value or less,
the predetermined condition includes a first condition in which rotation of the crank axle is stopped, and
the predetermined current value is greater than a standby current value of the motor and less than or equal to 5 amperes.

13. The control device according to claim 12, wherein
the predetermined current value is less than or equal to 2 amperes.

14. The control device according to claim 12, wherein
the human-powered vehicle further includes a derailleur configured to operate the transmission body and shift a transmission ratio of a rotational speed of the wheel to a rotational speed of the crank axle; and
the predetermined condition further includes a second condition in which the derailleur operates the transmission body to shift the transmission ratio.

15. The control device according to claim 14, wherein
in a case where a speed of the human-powered vehicle is less than or equal to a predetermined first speed, the electronic controller is configured to drive the motor so as to apply a propulsion force to the human-powered vehicle in accordance with at least one of the human driving force and the rotational speed of the crank axle;
the electronic controller is configured to control the derailleur; and
the electronic controller is configured so as not to actuate the derailleur upon determining the speed of the human-powered vehicle is in a predetermined speed range including the predetermined first speed in a case where the predetermined condition is satisfied.

16. The control device according to claim 1, wherein
the predetermined condition further includes a third condition in which the wheel is rotating.

17. The control device according to claim 12, wherein
the electronic controller is configured to determine that rotation of the crank axle is stopped in a case where a rotational speed of the crank axle is less than or equal to a predetermined rotational speed.

18. The control device according to claim 12, wherein:
the electronic controller is configured to drive the motor so that a rotational speed of the first rotational body becomes less than or equal to an estimated rotational speed; and
the estimated rotational speed is calculated from a transmission ratio of the human-powered vehicle and a speed of the human-powered vehicle.

19. The control device according to claim 12, wherein
in a case where the predetermined condition is satisfied, the electronic controller is configured to stop driving the motor in accordance with a load on the motor.

20. The control device according to claim 19, wherein
in a case where the electronic controller starts driving the motor as the predetermined condition is satisfied and the load on the motor then becomes greater than or equal to a predetermined load, the electronic controller is configured to stop driving the motor.

21. The control device according to claim 12, wherein
the predetermined condition includes a fourth condition in which the first condition is satisfied after a condition is satisfied in which the human driving force received by the crank axle is greater than or equal to a predetermined driving force.
